(19) United States
(12) Patent Application Publication
(10) Pub. No.: US 2005/0029259 A1
(43) Pub. Date: Feb. 10, 2005

(54) Stackable bowl sets shaped like segmented sport balls

(76) Inventor: William Billings Famham, San Pedro, CA (US)

Correspondence Address: William B. Famham, 847 West 28th Street, San Pedro, CA, 90731, US

(21) Appl. No.: 10/896,189

(22) Filed: Jul. 20, 2004

Related U.S. Application Data
(60) Provisional application No. 60/488,981, filed on Jul. 21, 2003.

(51) Int. Cl. A23B 4/00

(52) U.S. Cl. 220/4.27

(57) ABSTRACT

A set of food serving bowls in the form of a segmented sport ball. The basic set is comprised of a base bowl, a serving bowl, a dipping bowl, and a lid bowl. Each bowl has characteristics of resembling a portion of a sport ball. The individual bowls, when assembled as a set, take on the appearance of a sport ball such as a football, for example. The individual bowls have the ability to interchange to form various configurations for serving a variety of snack foods and condiments. The bowl sets have the ability to stack in a stable relationship, one set upon another set, for the purposes of storage, shipping, and retail display.

### CROSS-REFERENCE TO RELATED APPLICATIONS

This application claims the benefit of PPA Ser. No. 60/488,981 filed Jul. 21, 2003 by the present inventor.

### FEDERALLY SPONSORED REASEARCH

Not Applicable

### FIELD OF INVENTION

This invention relates to food serving bowls and dishes, primarily those used to serve snack foods and condiments that are shaped like segmented sport balls.

### BACKGROUND OF THE INVENTION

Description of Prior Art

It is widely known that sports fans enjoy food and beverage during the course of watching a sporting event or game on television, or being at the game. The time involved for a sport such as football, for example, to be played from start to conclusion is considerable. Therefore it is highly likely and quite common for spectators to become hungry during the course of the game. It has become a tradition in North America for a host to serve food and beverages to guests who are invited to watch a football game on television.

In the case of a sport such as football, it is customary for a portion of the fans who attend the games to participate in what is known as “Tailgate Parties”. These are primarily an outdoor festivity held on the grounds of the facility where the game is being played. This environment is not generally congenial to the kinds of dishes for serving food that are used in a normal table setting at a home or a restaurant as examples. Those serving dishes tend to be made from hard materials such as glass, china, and melamine which make them susceptible to breakage. Therefore, materials that are both durable and resistant to breakage such as plastic polymers and copolymers make superb candidates for use in an outdoor environment such as when ‘tailgating’.

A search of prior art will produce U.S. Pat. No. 6,041,918 issued to Moore (2000) as a example of an attempt to create a product that would be useful for the purposes of mimicking a sport ball and serving snack food to sports fans. Some of the disadvantages to using that invention for serving food become obvious when food is added to the container. The small footprint provided for keeping the bowl in an upright position during food service or as Moore calls it “a relatively planer surface region occupying a minor portion of the surface” makes the bowl subject to instability by either the user or by gravity.

Additionally, in the case of the above mentioned invention, the need to have the terminating edge or lip of the bowl “rolled inwardly upon itself” adds undesirable cost to the manufacturing of the product. It also creates pockets or voids about the circumference that become hosts for undesirable things such as moisture, foodstuff, bacteria, and rust to name a few. These substances are especially undesirable in a product that must be kept sanitary for the serving of food.

While Moores' invention appears to satisfy the objects of “a first incarnation as a retail package for the sale of snack food and usable thereafter as a serving bowl, or a coin bank, lampshade or other purpose” as so spelled out in U.S. Pat. No. 6,041,918, its ability to function as a suitable food serving bowl is limited. The need for a coin slot “extending through the inner surface and the outer surface” renders at least one of the mating sections incapable of retaining liquids or semi-viscous substances.

### OBJECTS AND ADVANTAGES

Accordingly, one of the objectives of the present invention is to create a suitable and stable platform from which to serve snack foods and condiments. Appearance, stability, ease of manufacture, cost, durability, functionality, and cleanliness are important factors to be considered when creating devices and articles such as the present invention. The ability to serve food in a stable manner, be cleaned and reused, and be easily stored taking up minimal space, are some of the advantages over the prior art.

Certain criteria are required for products that are designed for mass retailing. It is desirable for a product that is designed to be sold in retail stores to possess the ability to be stacked one upon another. This is in order to maximize the merchants' shelf space in regards to products displayed for sale. This means that shelf space consumed by the product is kept to a reasonable minimum. This is the reason so many of the products sold are encapsulated in rectilinear containers or boxes, as examples. This method allows the merchant to stock their shelves in an efficient manner so as to present for sale a sufficient quantity of a product without undue usage of shelf or floor space. The ability of a product to stack upon itself also is manifested in shipping of the product. The more product that can be carried in a given space on a truck or other shipping vessel the better. This reduces the overall cost of the product to the retailer as well as the consumer.

It is an object of my bowl sets to have the ability to be stackable in such a manner. The bowl sets of the present invention can be stacked for such purposes as storing, shipping, and display without the need for any added exterior packaging such a rectilinear container or box. This saves the consumer money that otherwise would be spent for packaging that would have no additional use and ultimately be discarded.

Additionally, the overall volume needed to stack two bowl sets is less than that required if exterior packaging such as a rectilinear container or box is required. This is accomplished by the concave underside area of the top set overlapping the convex topside of the bottom set.

### SUMMERY OF INVENTION

A set of food serving bowls in the form of a segmented sport ball. The basic set is comprised of a base bowl, a serving bowl, a dipping bowl, and a lid bowl. Each bowl has characteristics of resembling a portion of a sport ball. The individual bowls, when assembled as a set, take on the appearance of a sport ball such as a football, for example. The different bowls have the ability to interchange to form various configurations for serving a variety of snack foods and condiments. The bowl sets have the ability to stack in a stable relationship, one set upon another set, for the purposes of storage, shipping, and retail display.

### DRAWING FIGURES

FIG. 1 shows a bowl set, with a clear lid bowl, as it would appear for the purposes of storage or display in its most compacted form.

FIG. 1A shows a cross sectional view of the bowl set as it would appear for the purposes of storage or display in its most compacted form.

FIG. 2 shows an exploded view of the bowl set showing the individual bowls and how they relate to each other to allow for compact storage.

FIG. 3 shows a base bowl.

FIG. 4 shows a serving bowl.

FIG. 5 shows a dipping bowl that contains a smaller compartment centered in the middle of the bowl.

FIG. 6 shows a lid bowl that functions as a lid for any of the other bowls of the set, as well as a large serving bowl if inverted.

FIG. 7 shows the base bowl supporting the serving bowl.

FIG. 8 shows the base bowl supporting the dipping bowl.

FIG. 9 shows an inverted base bowl supporting an inverted lid bowl.

FIG. 10 shows an inverted base bowl supporting an inverted lid bowl (FIG. 20) supporting the serving bowl.

FIG. 11 shows an inverted base bowl supporting an inverted lid bowl (FIG. 20) supporting the dipping bowl.

FIG. 12 shows two (2) bowl sets stacked one upon the other.

FIG. 13 shows the details of the finger holds on the lid bowl.

FIG. 14 shows the details of the protrusions on the concave domed underside of the base bowl.

FIG. 15 shows the interlocking vertical flanges of the four (4) main bowls.

FIG. 16 shows the interlocking horizontal flanges of the four (4) main bowls.

### REFERENCE NUMERALS IN DRAWINGS

30 base bowl
32 serving bowl
34 dipping bowl
36 lid bowl
38 lid bowl vertical flange
40 dipping vertical bowl flange
42 serving bowl vertical flange
44 base bowl vertical flange
46 lid bowl horizontal flange
48 dipping bowl horizontal flange
50 serving bowl horizontal flange
52 base bowl horizontal flange
54 recess in lid bowl
56 vertical finger hold portion of recess in lid bowl
58 protrusion on underside of base bowl
60 vertical portion of protrusion on underside of base bowl
62 concave outer surface of domed underside of base bowl
64 convex inner surface of domed underside of base bowl
66 extending surfaces forming the walls of the cradle
68 convex outer walls of containers
70 concave inner walls of containers

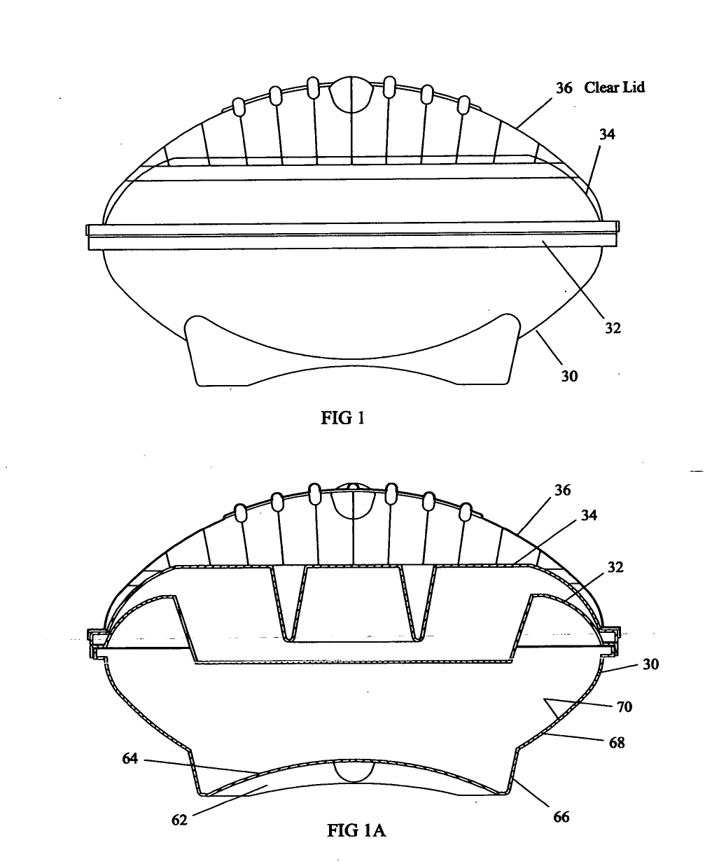

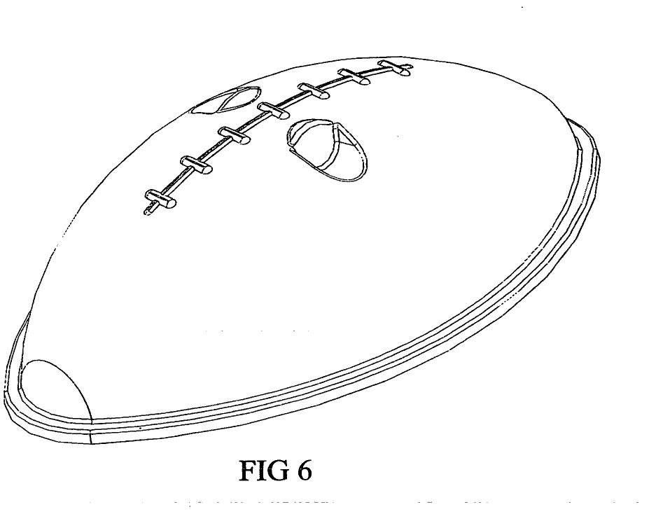

### DESCRIPTION OF INVENTION—FIGS. 1 TO 6

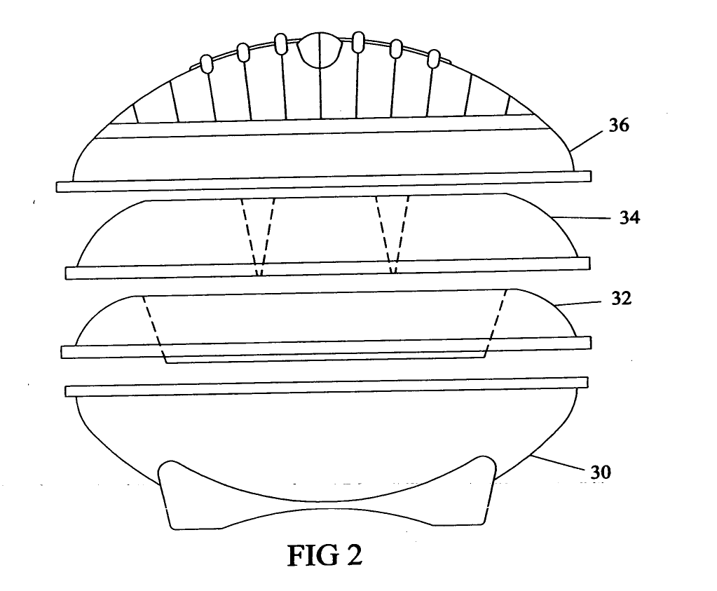

A typical embodiment of the set of bowls is illustrated in FIG. 1 as they would appear stacked for transportation, storage, or for display. FIG. 1A shows a cross sectional view of the long axis of the bowl set as it would appear stacked as a set. The convex outer walls 68, and the concave inner walls 70, as well as the domed underside concave outer surface 62 and opposing convex inner surface 64 can be seen. The exploded view of the bowls as they fit together for transportation, storage or display is illustrated in FIG. 2.

The individual bowls are comprised of a base bowl 30 (FIG. 3) having a shape roughly equivalent to one hemisphere, or half, of a sports ball with an integral cradle 66 at its bottom to allow for stability. In addition, the underside of the base bowl 30 (FIG. 14) is concave 62 to allow it to nest with the convex outer shape of the lid bowl 36. The base bowl 30 serves as the base support for the set of bowls.

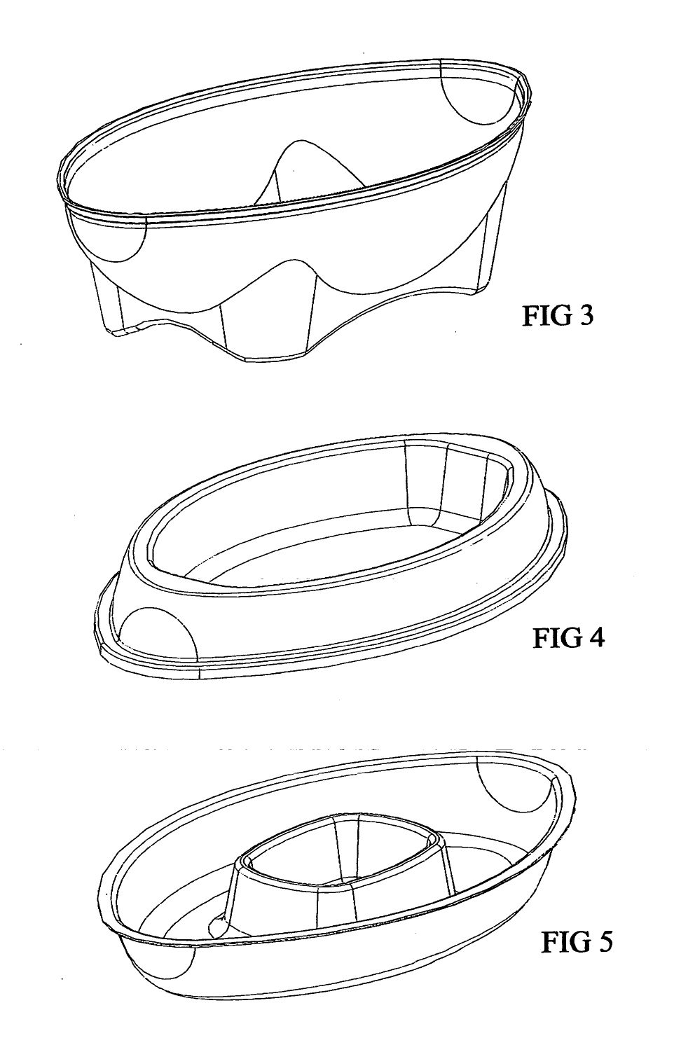

The set includes a serving bowl 32 (FIG. 4) with the floor of the bowl having an embossed design that has a resemblance to the playing field or court that the ball would be utilized on. This design helps tell the story of the game as well as providing for an enhanced visual appeal to the persons attracted to that sport.

The set includes a dipping bowl 34 that has a centralized integral portion with raised walls and a recessed floor that together with the perimeter raised walls comprise an inner and outer bowl. The floor of the inner bowl also has an embossed design (not shown) that has a resemblance to the playing field or court that the ball would be utilized on. This design also helps tell the story of the game as well as providing for an enhanced visual appeal to the persons attracted to that sport.

A lid bowl 36 (FIG. 6) having a shape roughly equivalent to one hemisphere, or half, of a sports ball can be used as serving bowl if inverted, or as a lid for the other bowls in the set. This lid bowl 36 has an embossed design that has a resemblance to the playing field or court that the ball would be utilized on. This design helps tell the story of the game as well as providing for an enhanced visual appeal to the persons attracted to that sport. The lid bowl has dimensions and characteristics that allow it to mate with other bowls of the set to form different configurations as well as nesting for transportation, storage or display.

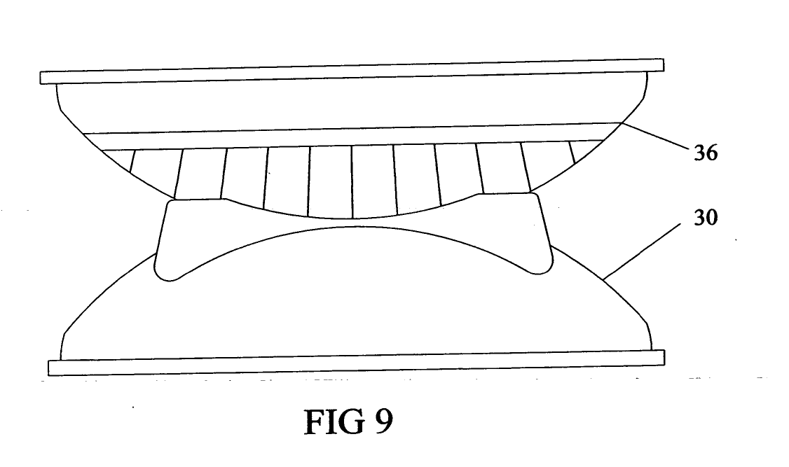

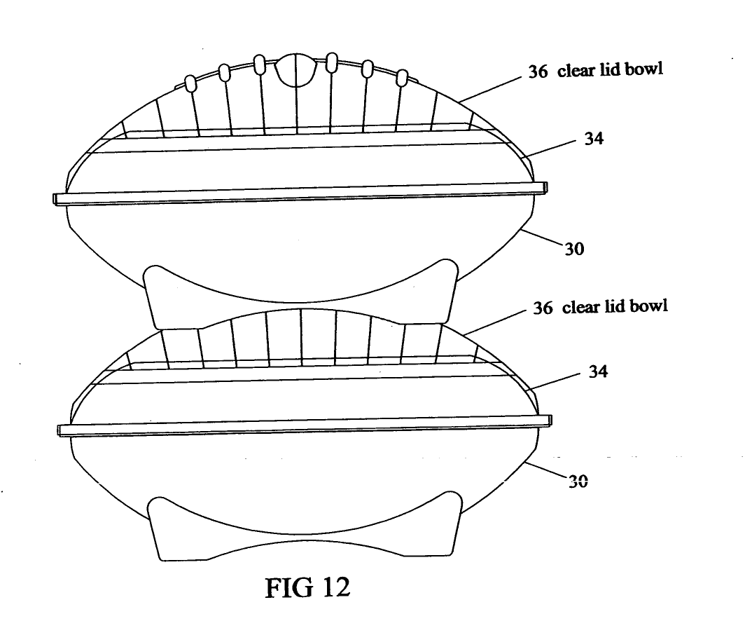

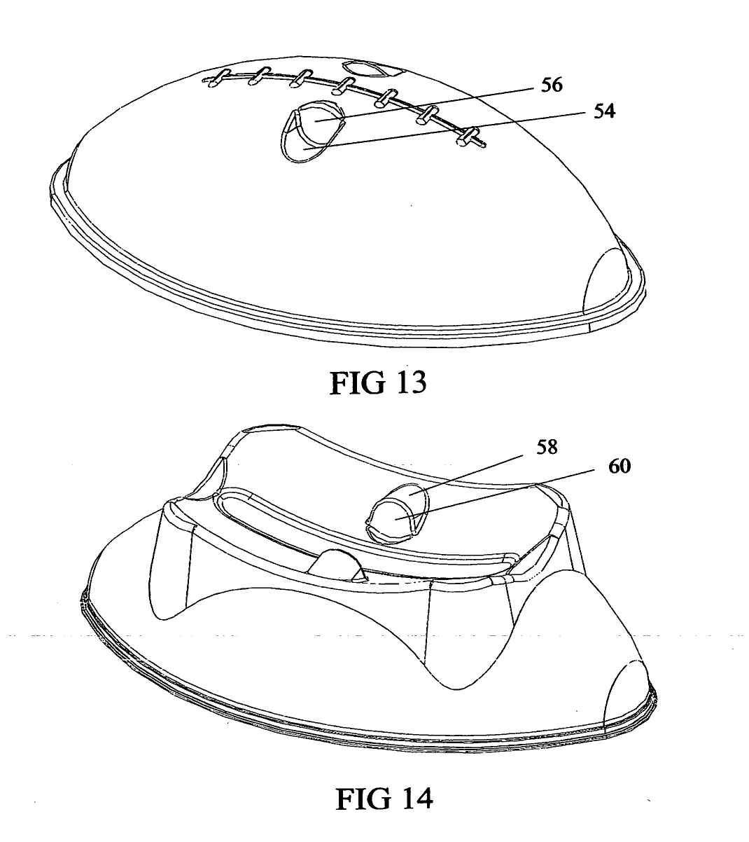

The lid bowl 36 has opposing recesses 54 near the center apex of its convex crown (FIG. 13) that allow for finger holds 56 to facilitate picking the lid up using primarily the thumb and one finger. These recesses 54 also function as a mechanism by which the lid bowl 36 can be joined to the underside of the base bowl 30 (FIG. 14) in a stable relationship to one another (FIG. 12). The underside of the base bowl 30, being concave, has protruding appendages 58 that fit into the recesses 54 of the lid bowl 36 and has a general shape that mimics the general shape of the lid bowl 36. This allows the two components to nest together for certain configurations of the bowls (FIGS. 9, 10, 11,) as well as for the stacking of multiple bowl sets during storage, transportation, or display (FIG. 12).

Due to the plurality of bowls, this set can at once provide for several types of foods, both hot and cold, solid or viscous, to be displayed for consumption. The plastic used for these bowls, in the preferred embodiment, has the ability to be used in a microwave and cleaned in a dishwasher.

The Base Bowl

The base bowl 30 can be used by itself or in conjunction with other members of the set. Additionally, by inverting the base bowl 30 (FIG. 14) and placing the inverted lid bowl 36 such that the protrusions 58 near the apex of the domed bottom portion of the base bowl 62 fit into the recesses 54 of the inverted lid bowl 36 (FIG. 13) you have made possible the configurations in FIGS. 9, 10, and 11. The base bowl 30, if inverted can be used as a lid to cover the serving bowl 32. This is true even if it is used in the configurations shown in FIGS. 9, 10, and 11. This bowl has dimensions and characteristics that allow it to mate with other bowls of the set to form different configurations as well as nesting for storage or display.

The Serving Bowl

The serving bowl 32 can be used by itself or in conjunction with other members of the set. The serving bowl 32 is configured to have the appearance of continuing the shape of the ball, north of the equator, for a portion of the height of the second (upper) hemisphere. Its overall height is truncated to allow for a plateau that has a recess comprising of downwardly shaped walls and a recessed floor that together create a bowl. The floor of the bowl has an embossed design that has a resemblance to the playing field or court that the ball would be utilized on. This design helps tell the story of the game as well as providing for an enhanced visual appeal to the persons attracted to that sport. This bowl has dimensions and characteristics that allow it to mate with other bowls of the set to form many different configurations as well as nesting for storage or display.

The Dipping Bowl

The dipping bowl 34 can be used by itself or in conjunction with other members of the set. The dipping bowl 34 has a centralized integral portion having raised walls and a recessed floor that together with the perimeter raised walls comprise an inner and outer bowl. This bowl within a bowl can be used for such things as dipping sauces and condiments. Additionally, this bowl could be used to keep separate different types of foods such as nuts and candies. The floor of the inner bowl has an embossed design (not shown) that has a resemblance to the playing field or court that the ball would be utilized on. This design helps tell the story of the game as well as providing for an enhanced visual appeal to the persons attracted to that sport.

When the dipping bowl 34 is inverted for storage or display, stacked together with the other bowls of the set, it is configured to have the appearance of continuing the shape of the ball, north of the equator, for a portion of the height of the second (upper) hemisphere having its overall height truncated. This bowl has dimensions and characteristics that allow it to mate with other bowls of the set to form many different configurations as well as nesting for storage or display.

The Lid Bowl

Placing the lid bowl 36 onto the any of the other bowls can aid in keeping the temperature and/or moisture content of the food more consistent than by having the food exposed to the ambient air or air movement. The finger holds 56 on the lid bowl 36 (FIG. 13) allow the lid to be easily placed onto, or removed from, the base bowl 30.

The lid bowl 36, if inverted, can be used with other members of the set (FIGS. 9, 10, 11). The lid bowl 36 has a shape roughly equivalent to one hemisphere, or half, of a sports ball and can be used as a serving bowl if inverted, or as a lid for the other bowls in the set. This bowl has dimensions and characteristics that allow it to mate with other bowls of the set to form different configurations as well as nesting for storage or display. The lid bowl 36 has opposing recesses 54 near the apex of its convex crown (FIG. 13) that allow for finger holds 56 to facilitate picking the lid up using primarily the thumb and one finger. These recesses 54 also function as a mechanism by which the lid bowl 36 can be joined to the underside of the base bowl 30 in a stable relationship (FIGS. 9, 10, 11 and 12).

The underside of the base bowl 30 (FIG. 14), being concave 62, has protruding appendages 58 that fit into the recesses 54 of the lid bowl 36 and has a general shape that mimics the general shape of the lid bowl 36. This allows the two components to nest together for certain configurations of the bowls (FIGS. 9, 10, 11) as well as for stacking during storage, transportation, or display (FIG. 12). Additional mechanisms (not shown) such as a snap-fit type of interlock that incorporates an interference fit between the vertical surfaces of the protrusions 60 and the vertical surfaces of the recesses 56 could be used to join the two components in a more positive manner. This snap-fit could have raised features on one of the components and recessed features on the opposing component, as an example. This means the protrusions 58 on the underside of the base bowl 30 would be joined to the recesses 54 of the lid bowl 36 in such a manner as to allow for a positive interlock of the two components thus helping to further stabilize their relationship to each other.

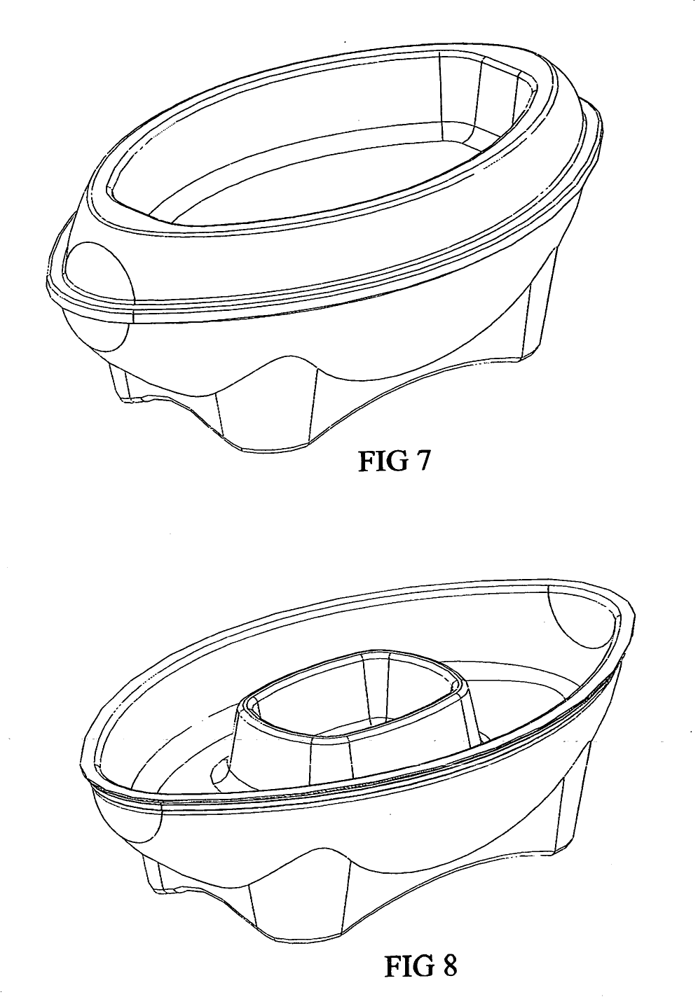

Operation—FIGS. 7 to 16

The manner in which the bowl set can be used is dependent on the purposes for which the user deems appropriate. This could be to serve cold foods such as food which is stored in a refrigerated environment prior to consumption, or ambient temperature foods, or foods that are best served warm or hot. Additionally, the bowls can be used in a microwave to heat the food prior to service.

Use of the Base Bowl

FIG. 7 illustrates how the base bowl 30 is used to support the serving bowl 32. The combination of the two bowls create a visual sense that you are looking at a majority view of a sports ball supported by a cradle. The base bowl 30 serves as the bottom half of a ball, sitting in a cradle, topped by a portion of the upper half of a sports ball. They are joined at the equator or belt line by engaging flanges that support and stabilize their relationship to one another. This configuration provides for an attractive and stable platform from which to serve food.

FIG. 8 illustrates how the base bowl 30 is used to support the dipping bowl 34. This configuration elevates the dipping bowl 34 off of the table surface or its equivalent. This configuration includes the ability to add a substance such as frozen water (ice), or its equivalent, to the base bowl 30 for the purposes of retaining or modifying the temperature of the food contained in the dipping bowl 34. This would be advantageous if the food was a perishable item such as shrimp, for example. The addition of the ice in the lower bowl would have a chilling effect on the food in the upper bowl. Consequentially, a heated substance would have a like effect, only producing heat as opposed to removing heat, to help keep the food at or closer to the desired serving temperature.

FIG. 9 illustrates the inverted base bowl 30 supporting the inverted lid bowl 36. An interlocking mechanism is created by the recessed finger holds 54 on the lid bowl 36 (FIG. 13) and the protrusions 58 (FIG. 14) on the concave surface of the underside of the base bowl 30. This helps to keep the lid bowl 36 centered and stabilized. Additionally, by placing the inverted lid bowl 36 onto the inverted base bowl 30 it raises the food off of the table into a more prominent serving position. The base bowl 30, when inverted can be used as a lid to cover the serving bowl 32. This is true even if it is used in the configurations shown in FIGS. 12, 13, and 14.

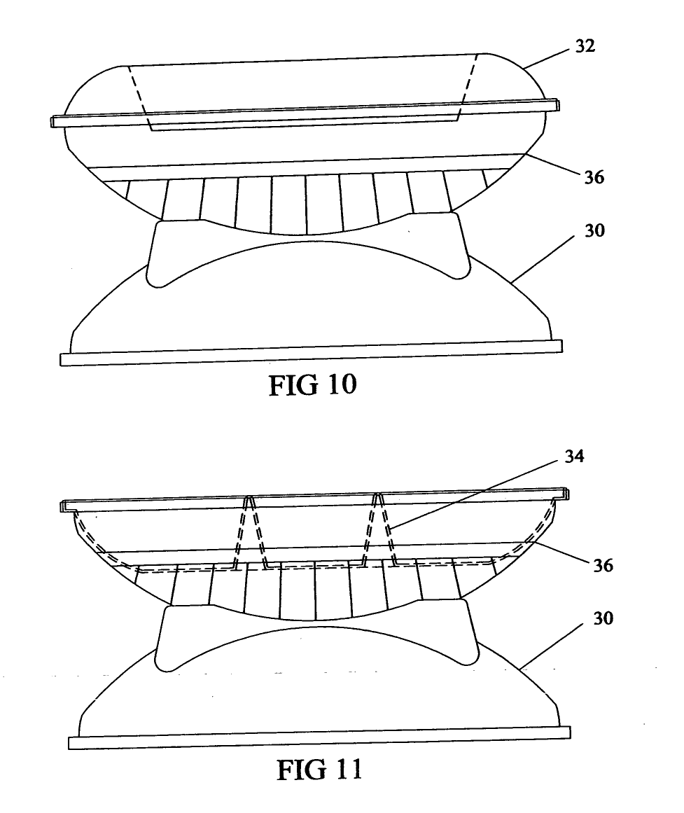

FIG. 10 illustrates the inverted base bowl 30 supporting the inverted lid bowl 36 supporting the serving bowl 32. This configuration helps to give the illusion of a more elegant service dish as the configuration takes on an almost ‘trophy like’ appearance. The illusion of the serving bowl 32 seemingly floating in space (providing the inverted lid bowl 36 is made of clear plastic) is visually appealing to the eye. It is also possible to fill the inverted lid bowl 36 with crushed ice, for example, for the purpose of keeping the food at or closer to the desired serving temperature if that desired temperature is below the ambient temperature.

FIG. 11 illustrates the inverted base bowl 30 supporting the inverted lid bowl 36 supporting the dipping bowl 34. This configuration helps to give the illusion of a more elegant service dish as the configuration takes on an almost ‘trophy like’ appearance. The illusion of the dipping bowl 34 seemingly floating in space (provided the inverted lid bowl 36 is made of clear plastic) is visually appealing to the eye. It is also possible to fill the inverted lid bowl 36 with crushed ice, for example, for the purpose of keeping the food at or closer to the desired serving temperature if that desired temperature is below the ambient temperature.

Two Bowl Sets Stacked

FIG. 12 illustrates two (2) football shaped bowls sets, one set placed onto the other set as they would be stacked for storage, transportation, or display. The concave domed bottom portion on the underside of the upper sets' base bowl 30 is sitting on the convex shape of the lid bowl 36 of the bottom set. The two (2) sets are held in a stable relationship by the protruding appendages 58 on the underside of the base bowl 30 (FIG. 14) of the upper set nesting in the opposing recesses 54 of the lower sets' lid bowl 36 (FIG. 13).

Interlocking Recesses and Protrusions

FIG. 13 illustrates how the lid bowl 36 has opposing recesses 54 near the center of its convex crown that allow for finger holds 56 to facilitate picking the lid up using primarily the thumb and one finger. These recesses 54 also function as a mechanism by which the lid bowl 36 can be joined to the underside of the base bowl 30 in a stable relationship for the purpose of stacking during storage, transportation, or display. Additional mechanisms such as a snap-fit type of interlock that incorporates an interference fit between the vertical surfaces of the protrusions 60 and the vertical surfaces of the recesses 56 could be used to join the two components in a more positive manner. This snap-fit could have raised features on one of the components and recessed features on the opposing component, as an example. This means the protrusions 58 on the underside of the base bowl 30 would be joined to the recesses 54 of the lid bowl 36 in such a manner as to allow for a positive interlock of the two components thus helping to further stabilize their relationship to each other.

FIG. 14 illustrates the underside of the base bowl 30, showing a concave surface that has protruding appendages 58 that fit into the opposing recesses 54 of the lid bowl 36, and has a general shape that mimics the general shape of the lid bowl 36. This allows the two components to nest to together for certain configurations of the bowls (FIGS. 9, 10, 11, and 12), as well as for the purposes of stacking during storage, transportation, or display.

Details of the Interlocking Flanges

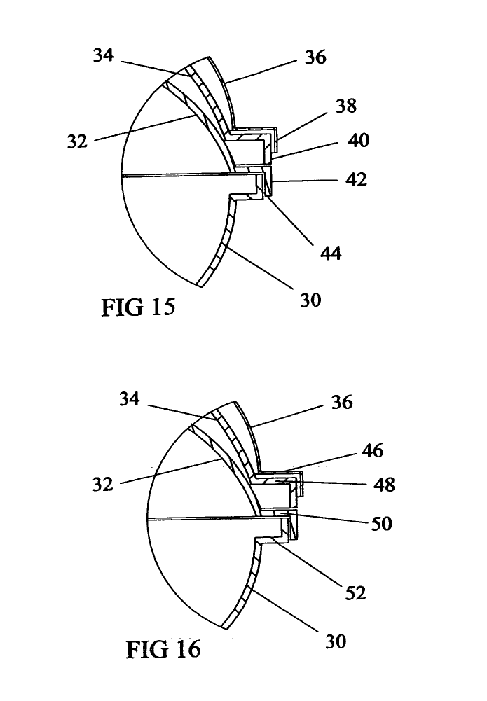

FIG. 15 illustrates an enlarged detailed cross sectional view of the bowl flanges. Flange 38 represents the vertical flange on the lid bowl 36. Flange 40 represents the vertical flange on the dipping bowl 34. Flange 42 represents the vertical flange on the serving bowl 32. Flange 44 represents the vertical flange on the base bowl 30. These vertical flanges are of varying lengths to allow for proper nesting and configuring of the bowl sets. These flanges represent the distal terminal edges of the walls of the receptacles.

FIG. 16 illustrates an enlarged detailed cross sectional view of the bowl flanges. Flange 46 represents the horizontal flange on the lid bowl 36. Flange 48 represents the horizontal flange on the dipping bowl 34. Flange 50 represents the horizontal flange on the serving bowl 32. Flange 52 represents the horizontal flange on the base bowl 30. These horizontal flanges are of varying lengths to allow for proper nesting and configuring of the bowl sets.

Conclusion, Ramifications and Scope:

The bowl set provides for the serving of food in a manner that is both delightful and convenient. The attractiveness of the packaging provides for a themed environment to add to the party atmosphere if used for such events such as ‘tailgate parties’ and the like. In the case of the football shaped serving bowls, for example, events such as the Superbowl create opportunities for the gathering of sports fans that are tailor made for throwing a party. Food and drink are a prerequisite if the partygoers are expected to enjoy themselves. What could be more delightful than enjoying your favorite foods or snacks displayed on attractive serving dishes that also contribute to the festive mood of the party by mimicking the theme of the event.

Likewise, a set of bowls shaped to resemble a basketball, for instance, would certainly be appreciated by those attending a “March Madness” festivity. A soccer ball shaped set would no doubt be desirable at a “World Cup” party. Sports fans are known to be fanatical about ‘their sport’ and tend to desire objects that reflect their enthusiasm for the sport.

A large advantage to having a set of serving dishes that are both practical and whimsical at the same time is the ability to separate the fanciful from the ordinary. It is not hard to imagine that the use of ordinary everyday plates and bowls for a ‘tailgate party’, for instance, would not add to the ambiance in the same manner that the football shaped bowls would.

Additionally, a dedicated set of serving dishes would help to alleviate the aggravation of using the same dishes that are normally used in the home, at a remote site that may contribute to the demise of a matched set of serving ware. This could have a healthy effect on ones' marriage, per se, especially if one of the spouses does not partake or appreciate the ‘art of the tailgate’. The same holds true should the party be thrown at ones' home or place of work.

Sport seasons are spaced around the calendar to allow for uninterrupted weeks or months of enjoyment of a particular sport so as not to dilute the available pool of sport fans. This is why it can be imagined that one who enjoys football, for example, also most likely has another sport such as basketball that is also fanatically enjoyed by that individual. This is why it is desirable to have differently shaped bowls that reflect the individual sport for use during the duration of that sports' season.

The bowl set could be made of durable plastic that can withstand the rigors of repeated usage and cleaning, as well as being microwaveable and freezable. Another embodiment would be the use of plastic that is disposable at the end of the game or event. This would aid in the ease of cleanup. Additionally, the individual bowls could be configured, using as an example, the base bowl 30 and the lid bowl 36 only, as disposable units that could be adapted as ‘take-out’ or ‘carry-out’ packaging for restaurants and home delivery food establishments. It's also not hard to imagine being at the game and taking your food from a vendor station back to your seat in one of these attractive packages. The package could be disposed of at the stadium or taken home as a souvenir of the game. This would work for either a durable plastic material or a disposable plastic material.

Additional uses for these sport ball shaped bowl sets are settings such as sports bars, and clubs that provide their patrons with free snacks and ‘happy hour’ foods. Collages, High Schools, Boys and Girls Clubs, for example, regularly hold events that would be perfect settings for these sport ball shaped serving bowls. These sets could be made in a variety of sizes to accommodate the venue, large for public gatherings, regular size for private use, small for children's parties, etc.

While my above description contains many specifications, these should not be construed as limitations on the scope of the invention, but rather as an exemplification of one preferred embodiment thereof. Many other variations are possible. For example, aside from the food related uses, these bowl sets can be used for such diverse things as toys, nick-knack containers, jewelry boxes, cigar and tobacco boxes, storage for hardware items such as nuts, bolts, screws, and nails, as coin depositories, sewing boxes, desk organizers, or storage for any items, materials, or substances that can fit into the spaces provided by the interior volumes of the bowls.

The bowl set is designed to be injection molded. Thermoforming (vacuum forming) and blow molding techniques can be used to manufacture the bowl set. It is possible, however, to use fiberglass, ceramics or thermoset plastics in the manufacture of these bowls. The bowl set could also be made from materials such as stainless steel, aluminum, brass or copper, or any malleable material that tends to hold a shape. The individual bowls all could be made of the same material, or of different materials, or composites of multiple-materials.

In addition, some of the bowls may be eliminated or duplicated, connected to one another by hinges, living hinges, snaps, or other locking or interlocking mechanisms. The embossed designs could be eliminated or altered in their design, or applied in different manners such as decals, silk screening, engraving or applied with a branding iron, to name a few examples.

1. A set of food serving bowls in the shape of a segmented sport ball comprising:
(a) a first container having a substantially convex outer surface opposing a substantially concave inner surface, said surfaces acting as walls defining a substantially concave internal cavity having a curvilinear circumference about its distal terminal edge defining an opening, said first container having a domed bottom portion, being a substantially concave outer surface opposing a substantially convex inner surface, together with the walls forming a receptacle defining substantially one hemisphere, or half, of a sport ball, and
(b) said first container having a plurality of predetermined opposing protrusions, inwardly terminating in substantially vertically opposed surfaces, on said concave outer surface of said domed bottom portion, in proximity to a central apex of said domed bottom portion, and
(c) said second container having a substantially convex outer surface opposing a substantially concave inner surface defining a substantially concave internal cavity having a curvilinear circumference about its distal terminal edge defining an opening, said second container forming substantially an opposing hemisphere, or half, of said sport ball, and
(d) said second container having a plurality of opposed recesses in said outer convex surface terminating inwardly in substantially parallel vertical surfaces, said parallel vertical surfaces disposed in a substantially perpendicular orientation to a plane defined by said distal terminal edges, said opposed recesses being in proximity to a central apex of said hemisphere, and
(e) said distal terminal edges having means, including flanges, to mate said first container with said second container at said distal terminal edges in an engaged relationship whereby substantially the entirety of a sport ball is formed, and
(f) means, including interlocking protrusions and recesses, for said first container to nest in a predetermined stable relationship with said second container such that the concave outer surface of said domed bottom portion of said first container overlappingly mates with said convex outer surface of said second container such that said apexes coincide along a common axis perpendicular to a plane defined by said distal terminal edges, said distal terminal edges of said first container being substantially parallel with said distal terminal edges of said second container,
whereby a predetermined stable relationship between said first container and said second container is provided to allow for both,
(a′) said second container to sit atop said first container, together forming a receptacle in the shape of a sport ball with a removable lid, and
(b′) said first container to sit atop said second container in a predetermined stable relationship for the purpose of stacking the container sets for shipping, storage, and retail display.

2. The bowl set of claim 1 wherein the bowl set comprises individual pieces made of injection molded plastic.

3. The bowl set of claim 1 wherein the bowl set comprises individual pieces made of vacuum formed plastic.

4. The bowl set of claim 1 wherein additional bowls resembling segments of a sport ball are included in the set.

5. The bowl set of claim 2 wherein additional bowls resembling segments of a sport ball are included in the set.

6. A set of food serving bowls in the shape of a segmented sport ball comprising:
(a) a plurality of containers each having substantially convex outer walls, opposing concave inner walls, having curvilinear circumferences about their distal terminal edges defining an opening, the walls forming a substantially concave internal cavity whereby each container is defining substantially one opposing hemisphere, or half, of a sport ball, and
(b) said containers having said terminal edges having means, including flanges, to mate a first container with a second container at said distal terminal edges in a engaged relationship whereby substantially a whole of a sport ball is formed, and
(c) said first container having a domed bottom portion comprising a substantially concave outer surface opposing a substantially convex inner surface, adjoining surfaces, acting as walls, extending and protruding vertically from a portion of said hemisphere in a substantially perpendicular orientation to a plane defined by said distal terminal edges, together forming the base of the receptacle, such that the substantially vertical rise of said walls creates an integral cradle to support said hemisphere with said opening in an upright posture, and
(d) said second container having a plurality of recesses, inwardly terminating in substantially vertically opposed surfaces in said outer convex walls of said hemisphere, in proximity to a central apex of said hemisphere having means for a human hand to lift the container using primarily a thumb and one finger when said opening is in a downward posture,
whereby the set of bowls mate to form a receptacle with a removable lid in the shape of a cradled sport ball.

7. The bowl set of claim 6 wherein the bowl set comprises individual pieces made of injection molded plastic.

8. The bowl set of claim 6 wherein the bowl set comprises individual pieces made of vacuum formed plastic.

9. The bowl set of claim 6 wherein additional bowls resembling segments of a sport ball are included in the set.

10. The bowl set of claim 7 wherein additional bowls resembling segments of a sport ball are included in the set.

11. A set of food serving bowls in the shape of a segmented sport ball comprising:
(a) a first container having a substantially convex outer surface opposing a substantially concave inner surface, said surfaces acting as walls defining a substantially concave internal cavity having a curvilinear circumference about its distal terminal edge defining an opening, said first container having a domed bottom portion, being a substantially concave outer surface opposing a substantially convex inner surface, together with the walls forming a receptacle defining substantially one hemisphere, or half, of a sport ball, and
(b) said first container having a plurality of predetermined opposing protrusions, inwardly terminating in substantially vertically opposed surfaces, on said concave outer surface of said domed bottom portion, in proximity to a central apex of said domed bottom portion, and
(c) said first container having a domed bottom portion comprising a substantially concave outer surface opposing a substantially convex inner surface, adjoining surfaces, acting as walls, extending and protruding vertically from a portion of said hemisphere in a substantially perpendicular orientation to a plane defined by said distal terminal edges, together forming the base of the receptacle, such that the substantially vertical rise of said walls creates an integral cradle to support said hemisphere with said opening in an upright posture, and
(d) said second container having a substantially convex outer surface opposing a substantially concave inner surface defining a substantially concave internal cavity having a curvilinear circumference about its distal terminal edge defining an opening, said second container forming substantially an opposing hemisphere, or half, of said sport ball, and
(e) said second container having a plurality of opposed recesses in said outer convex surface terminating inwardly in substantially parallel vertical surfaces, said parallel vertical surfaces disposed in a substantially perpendicular orientation to a plane defined by said distal terminal edges, said opposed recesses being in proximity to a central apex of said hemisphere, and
(f) said distal terminal edges having means, including flanges, to mate said first container with said second container at said distal terminal edges in an engaged relationship whereby substantially the entirety of a sport ball is formed, and
(g) means, including interlocking protrusions and recesses, for said first container to nest in a predetermined stable relationship with said second container such that the concave outer surface of said domed bottom portion of said first container overlappingly mates with said convex outer surface of said second container such that said apexes coincide along a common axis perpendicular to a plane defined by said distal terminal edges, said distal terminal edges of said first container being substantially parallel with said distal terminal edges of said second container,
whereby a predetermined stable relationship between said first container and said second contain-er is provided to allow for both,
(a′) said second container to sit atop said first container, together forming a receptacle in the shape of a cradled sport ball with a removable lid, and
(b′) said first container to sit atop said second container in a predetermined stable relationship for the purpose of stacking the container sets for shipping, storage, and retail display.

12. The bowl set of claim 11 wherein the bowl set comprises individual pieces made of injection molded plastic.

13. The bowl set of claim 11 wherein the bowl set comprises individual pieces made of vacuum formed plastic.

14. The bowl set of claim 11 wherein additional bowls resembling segments of a sport ball are included in the set.

15. The bowl set of claim 12 wherein additional bowls resembling segments of a sport ball are included in the set.
